(19) United States
(12) Patent Application Publication
(10) Pub. No.: US 2016/0191589 A1
(43) Pub. Date: Jun. 30, 2016

(54) SYSTEMS AND METHODS FOR GUIDING A DISABLED INDIVIDUAL

(71) Applicant: SLING MEDIA INC., Foster City, CA (US)

(72) Inventor: Andrey L. Abramov, Foster City, CA (US)

(21) Appl. No.: 14/983,963

(22) Filed: Dec. 30, 2015

Related U.S. Application Data
(60) Provisional application No. 62/098,533, filed on Dec. 31, 2014.

(51) Int. Cl. H04L 29/06; H04L 29/08

(52) U.S. Cl. CPC H04L 65/4092; H04L 65/80; H04L 65/607; H04L 67/02

(57) ABSTRACT

A media streaming device is disclosed that is capable of and configured to determine a suitable frame rate and/or suitable resolution of media to be delivered to a media client during a streaming initialization process. Thus, as described herein, a media stream may be delivered to a media client such that the media stream is not initially disrupted or non-optimal. Rather, the initial media frames may be delivered at a speed and quality that is appropriate or substantially appropriate (e.g., substantially optimal) based upon an initial assessment of the quality of the network or media streaming connection.

### CROSS-REFERENCE TO RELATED APPLICATIONS

This application claims the benefit of priority to U.S. Provisional Application Ser. No. 62/098,533, filed on Dec. 31, 2014, the contents of which are herein incorporated by reference in their entirety.

### TECHNICAL FIELD

The present disclosure generally relates to the delivery of digital media content, and more particularly to guiding a disabled individual using a media streaming service, where the media streaming service may employ streaming initialization processes, systems, and/or devices described herein.

### BACKGROUND

In general, media streaming devices are those that allow content to be streamed from a media source or capture device (e.g., a DVR or set top box) to a media client (e.g., a computer or a mobile communication device). Typically a media streaming device acts as a real time encoder that streams content from the media source device to the media client. Some media streaming devices are referred to as “placeshifting” devices. These devices may encode a media stream for streaming to a media client. An example placeshifting device is described in U.S. Published Patent Application No. 2006/0095471, entitled PERSONAL MEDIA BROADCASTING SYSTEM, filed Jun. 7, 2005, which is hereby incorporated by reference in its entirety.

Conventional media streaming devices (including placeshifting devices) may determine and/or adjust a frame rate at which to transmit or stream media to a media client based upon one or more ongoing communications received from the media client as media is streamed to the media client. However, one disadvantage of existing media streaming devices is that the frame rate and/or resolution may not be adjusted to accommodate a network connection speed or quality between a media streaming device and a media client until media is being streamed to the media client. Thus, at the outset, a frame rate and/or resolution of the media stream may be inappropriate to the network connection (i.e., too great or too small), resulting, for example, in a choppy, intermittent, slowed, lower than necessary resolution, etc. media stream. A media streaming device for more rapidly determining an ideal or suitable media streaming frame rate and/or resolution is therefore desirable.

In addition, conventional media streaming services have focused mainly on the delivery of media to media viewers for entertainment purposes. For instance, live media, such as a sports game, may be streamed to a media viewer. Thus, media streaming services have, typically, been limited in their application. It would therefore be advantageous to extend the application of media streaming services to other purposes, such as, for example, to the purpose of providing assistance to disabled (e.g., vision impaired) individuals.

### BRIEF DESCRIPTION

As described above, conventional media streaming (e.g., placeshifting) devices may establish or adjust a media streaming frame rate based upon a quality of a network or media streaming connection. The quality of the connection is typically determined, however, based upon data that is received as the media is streamed to a media client. Thus, as a streaming connection is initialized and media frames are initially transmitted to a media client, often, no measure of the network quality is available, resulting, in many instances, in the delivery of frames to a media client at an inappropriate frame rate (e.g., too many frames per second, too few frames per second) and/or at an inappropriate resolution (e.g., to great or low a resolution). As a result, a media stream may appear choppy, slow, intermittent, and the like as frames are initially delivered.

Accordingly, in various embodiments, a media streaming device is disclosed that is capable of and configured to determine a suitable frame rate and/or suitable resolution of media to be delivered to a media client during a streaming initialization process. Thus, as described herein, a media stream may be delivered to a media client such that the media stream is not initially disrupted or non-optimal. Rather, the initial media frames may be delivered at a speed and quality that is appropriate or substantially appropriate (e.g., substantially optimal) based upon an initial assessment of the quality of the network or media streaming connection.

In addition, and as described above, many conventional media streaming services have focused on the delivery of entertainment media, such as sports media. Thus, in various embodiments, a media streaming service that is capable of streaming media from a wearable media streaming device (coupled to a wearable media recorder) to a media client associated with an operator, who may provide audible guidance to an individual outfitted with the wearable media streaming device, is disclosed. Additionally, in various embodiments, the streaming frame rate and/or resolution of video captured by the wearable media recorder may be adjusted during an initialization process by a media streaming device, as described herein.

Still other embodiments provide additional processes, systems and devices for adjusting the frame rate and/or resolution of streaming data as well as to providing guidance to disabled individuals. The examples presented in this brief description may be modified or augmented in any manner, and many additional examples are described below.

### BRIEF DESCRIPTION OF THE DRAWING FIGURES

Exemplary embodiments will hereinafter be described in conjunction with the following drawing figures, wherein like numerals denote like elements, and

FIG. 1 shows, in accordance with various embodiments, a system for streaming digital media from media streaming device to a media client;

FIG. 2 shows, in accordance with various embodiments, a process for rapidly determining a media streaming frame rate during a media streaming initialization process;

FIG. 3 shows, in accordance with various embodiments, a system for streaming digital media from a wearable media streaming device to a media client in order to provide guidance to a disabled individual; and

FIG. 4 shows, in accordance with various embodiments, a process for streaming digital media from a wearable media streaming device to a media client in order to provide guidance to a disabled individual.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

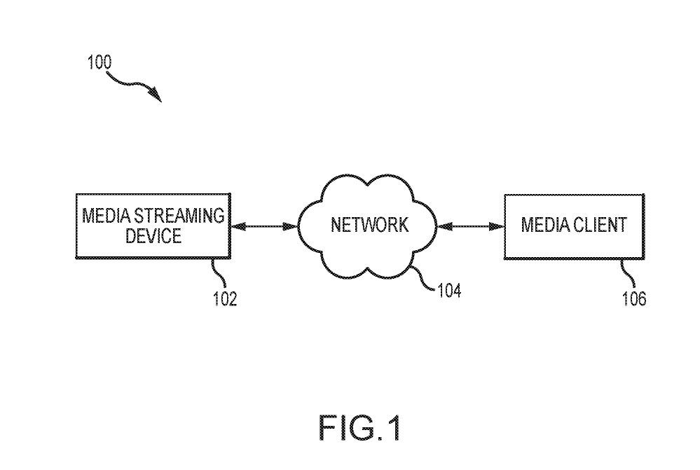

Turning now to the drawing figures, FIG. 1, a system 100 for rapidly determining a media streaming frame rate and guiding a disabled individual is shown. The system 100 may comprise a media streaming device 102, a network 104, and/or a media client 106.

A media streaming device 102 may comprise any device that may encode and/or stream media in real time or substantially real time. For example, a media streaming device 102 may comprise any suitably configured media streaming and/or placeshifting device (such as, for example, the placeshifting device described in U.S. Published Patent Application No. 2006/0095471, entitled PERSONAL MEDIA BROADCASTING SYSTEM, filed Jun. 7, 2005, which is incorporated by reference in its entirety above).

A network 104 may comprise any computer network, such as the internet, a local area network, a wide area network, and the like. The media streaming device 102 may be communicatively coupled to the network 104 and may stream media over the network.

A media client 106 may comprise any device configured to and/or capable of receiving streaming digital media content. Thus, for example, a media client 106 may comprise any computing device, such as a television, a personal computer, a smartphone, a tablet computing device, a wearable computing device having a display, and the like. The media client 106 may be communicatively coupled to the network 104 and may receive, as described herein, data streamed over the network 104 by the media streaming device 102. Thus, the media streaming device 102 may be coupled, through the network 104, to the media client 106.

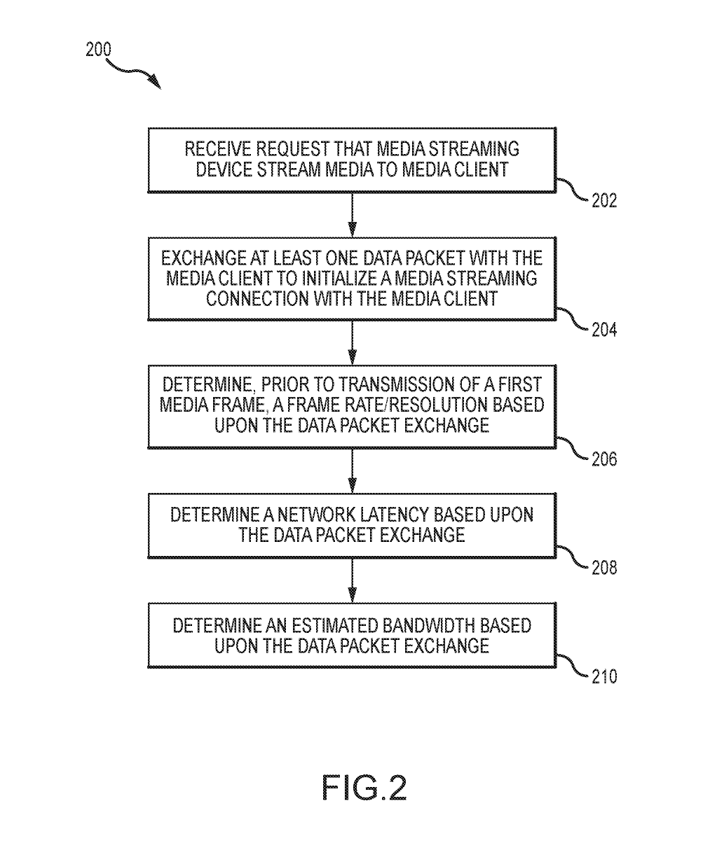

With reference to FIG. 2, an example process 200 for rapidly determining a media streaming frame rate and/or guiding a disabled individual is shown. The process 200 may be executed by any media streaming device 102 suitably configured to execute the process 200. For example, in various embodiments, a media streaming device 102 may execute one or more instructions stored on a non-transitory computer-readable memory and/or medium communicatively coupled to and/or comprising the media streaming device 102 to execute the process 200.

Accordingly, in various embodiments, a media client 106 may request that a media streaming device 102 stream media to the media client 106 (step 202). In response, the media streaming device 102 may exchange at least one data packet with the media client 106 to initiate or initialize a media streaming connection with the media client 106 (step 204). Thus, a data packet exchange may initialize a media streaming connection between the media streaming device 102 and the media client 106.

In response to the data packet exchange, the media streaming device 102 may determine, prior to transmission of a first media frame (e.g., a first image of a video), a frame rate and/or resolution at which to stream the media to the media client 106 (step 206). The media streaming device 102 may determine the frame rate and/or resolution based upon the data packet exchange. For example, in various embodiments, the media streaming device 102 may determine the frame rate and/or resolution based upon a number of network hops (i.e., a number of network nodes or computers communicatively coupled to the network 104) that the data packet makes during transmission to the media client. In various embodiments, the fewer the number of network hops, the greater the frame rate and/or resolution. Likewise, the greater the number of network hops, the lesser the frame rate and/or resolution. Moreover, in various embodiments, the media streaming device 102 may determine the frame rate and/or resolution based upon a time delay between transmission of the data packet from the media streaming device 102 to reception of the data packet by the media client 106.

As described herein, however, the frame rate and/or resolution may be determined, based upon the number of network hops required to stream the data packet from the media streaming device 102 to the media client 106 over the network 104, prior to transmission of a first media frame—that is, prior to beginning streaming of the requested media stream. Thus, the media streaming device 102 may improve the quality of an initial portion or sequence of media frames of a media stream, because a frame rate and/or resolution appropriate to a network 104 speed and/or quality may be determined prior to beginning streaming of the media.

Further, in various embodiments, the media streaming device 102 may determine, based upon the data packet exchange described above (e.g., the number of network hops required to transmit a data packet from the media streaming device 102 to the media client 106 and/or a time taken to complete the data packet exchange) a network latency (step 208). A network latency may be measured in time, hops, and the like. Similarly, in various embodiments, the media streaming device 102 may determine a bandwidth of the network 104 (step 210). In various embodiments, a hop count may be used, not only in the context of a system for guiding a disabled individual, but in any media streaming system. Thus, for example, a hop count may be used to determine a network latency in any placeshifting system or context.

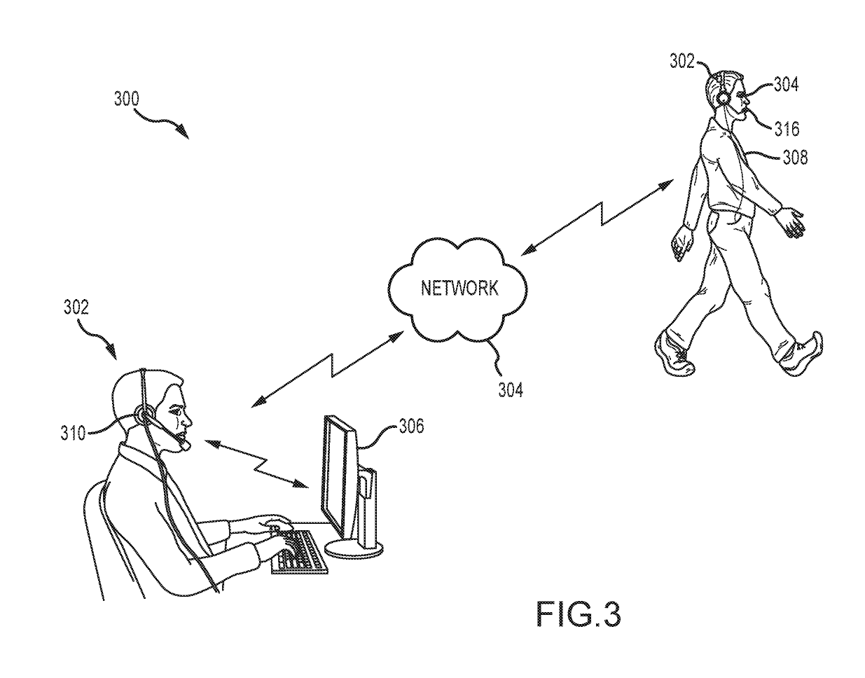

With attention now to FIG. 3, a system 300 for streaming digital media from a wearable media streaming device 302 to a media client 306 in order to provide guidance to a disabled individual 308 is shown. The disabled individual 308 may be a vision impaired individual.

Accordingly, in various embodiments, the system 300 may comprise the wearable media streaming device 302, a network 304, the media client 306, an operator audio interface 310 associated with an operator individual 312, a wearable media capture device 314, and/or a disabled individual audio interface 316 associated with the disabled individual 308.

As described above, the wearable media streaming device 302 may comprise (like the media streaming device 102) any media streaming or placeshifting device that is wearable by the disabled individual 308 and/or suitably configured to encode, placeshift, and/or stream media to the media client over the network 304. The network 304 may comprise any suitable network, as described above with respect to network 304. Thus, the wearable media streaming device 302 may be communicatively coupled to the network 304 (e.g., via a wireless connection to the network 304).

The media client may 306 may, like the media client 106, comprise any device configured to and/or capable of receiving streaming digital media content. Thus, for example, a media client 306 may comprise any computing device, such as a television, a personal computer, a smartphone, a tablet computing device, a wearable computing device having a display, and the like. The media client 306 may be communicatively coupled to the network 304 and may receive, as described herein, data streamed over the network 304 by the wearable media streaming device 302. Accordingly, the wearable media streaming device 302 may be coupled, through the network 304, to the media client 306.

The operator audio interface 310 and/or the disabled individual audio interface 316 may, in various embodiments, comprise an audio receiver, such as a microphone, and/or an audio transmitter, such as a speaker. Each audio interface 310 and/or 316 may be coupled to and/or comprise a headset or otherwise be capable of being fitted to or worn, as an item, by the operator individual 312 and/or the disabled individual 308.

The wearable media capture device 314 may comprise any suitable media capture device, such as, for example, a wearable video camera. The wearable media capture device 314 may, like the disabled individual audio interface 316, be fitted to and/or otherwise worn, as an item, by the disabled individual 308. In various embodiments, the media client 306 may comprise a wearable item (to be worn by the operator individual 312) in similar fashion. The wearable media capture device 314 may be mounted with and/or comprise, together with the disabled individual audio interface 316, a headset and/or other unitary item to be fitted to and/or worn, as an item, by the disabled individual 308.

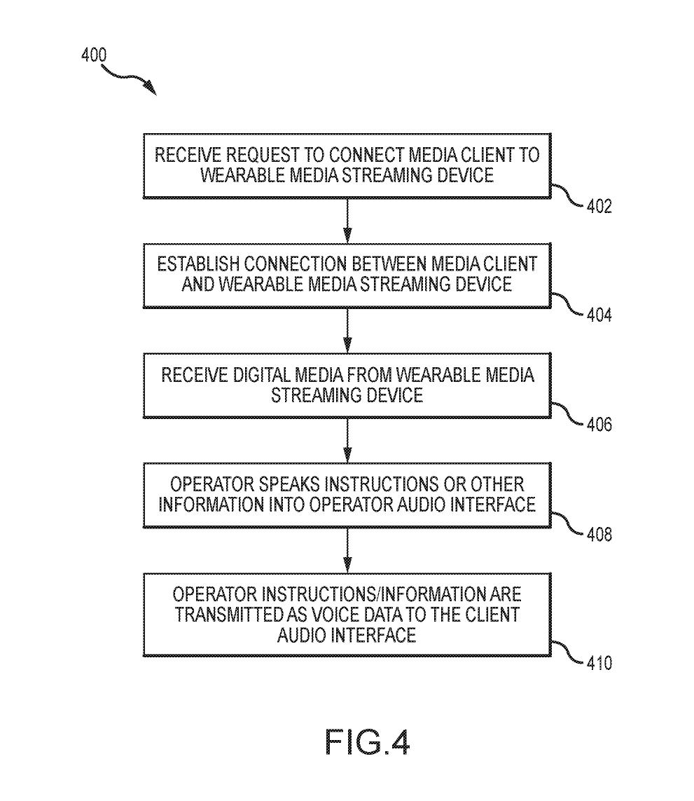

Turning, then, to FIG. 4, a process 400 for streaming digital media from the wearable media streaming device 302 to the media client 306 in order to provide guidance to the disabled individual 308 is shown. In various embodiments, the wearable media streaming device 302 may request (at the behest of the disabled individual 308) a connection to the media client 306 (step 402). The connection between the media client 306 and the wearable media streaming device 302 may be initiated, as described above, such that a data packet is transmitted from the wearable media streaming device 302 to establish a frame rate and/or resolution based, for example, on the number of hops required to transmit the data packet from the wearable media streaming device 302 to the media client 306. Thus, a connection between the wearable media streaming device 302 and the media client 306 may be established (step 404).

The wearable media capture device 314 may record or capture media (e.g., video) as the disabled individual 308 travels in the real world. The media or data captured by the wearable media capture device 314 may be transmitted to the wearable media streaming device 302, which may encode and stream the data via the network 304 to the media client 306 (step 406). As the media client 306 receives the encoded data, the media client 306 may decode and display the streaming data in real time (or real time including a processing and/or streaming delay) for the operator individual 312.

The operator individual 312 may, in response to the data stream, speak or text one or more instructions (e.g., instructions for movement) and/or any other information or text or voice data into the audio receiver portion (or a text receiving portion, such as a textual interface) of the operator audio interface 310 (step 406). This information may be transmitted, via the network 304, to the audio transmitter portion (or a text receiving portion) of the disabled individual audio interface 316 (step 408). Thus, the disabled individual 308 may receive audible or textual instructions and/or other information, relayed via the network 304, from the operator individual 312. These instructions and/or information may help the disabled individual 308 to navigate a path of the disabled individual in the real world. For instance, the operator individual 312 may alert the disabled individual 308 to an upcoming stop sign or stop light if the disabled individual is on foot and/or otherwise approaching an upcoming destination.

In like manner, the disabled individual 308 may communicate instructions and/or information via the disabled individual audio interface 316 to the operator via the network 304. These instructions and/or information may be received, as described above, by the operator individual 312 via the operator audio interface 310. The system 300 may thus permit the operator individual 312 to receive real time streaming media from the perspective of the disabled individual 308 and, in response, to provide any of a variety of helpful instructions and/or information to the disabled individual in real time.

The terms “exemplary” and “example” are used herein to represent one example, instance or illustration that may have any number of alternates. Any implementation described herein as exemplary is not necessarily to be construed as preferred or advantageous over other implementations. While several exemplary embodiments have been presented in the foregoing detailed description, it should be appreciated that a vast number of alternate but equivalent variations exist, and the examples presented herein are not intended to limit the scope, applicability, or configuration of the invention in any way. To the contrary, various changes may be made in the function and arrangement of elements described without departing from the scope of the claims and their legal equivalents.

What is presently claimed is:

1. A process for rapidly determining a media streaming frame rate, the process comprising:
receiving, by a media streaming device and from a media client, a request that the media streaming device stream media to the media client;
exchanging, by the media streaming device and by way of a network, at least one data packet with the media client to initialize a media streaming connection with the media client;
determining, by the media streaming device and prior to transmission of a first media frame to the media client, a frame rate at which to stream the media to the media client, the determining based upon the data packet exchange; and
encoding, by the media streaming device and at the determined frame rate in real time, the media to the media client.

2. The process of claim 1, further comprising determining, by the media streaming device, a network latency based upon the data packet exchange.

3. The process of claim 1, further comprising determining, by the media streaming device, a number of network hops associated with the data packet exchange.

4. The process of claim 1, further comprising determining, by the media streaming device, a frame rate at which to stream the media to the media client based upon a number of network hops associated with the data packet exchange.

5. The process of claim 1, further comprising determining, by the media streaming device, a resolution at which to stream the media to the media client based upon a number of network hops associated with the data packet exchange.

6. The process of claim 1, further comprising determining, by the media streaming device, an estimated bandwidth of the media streaming connection based upon the data packet exchange.

7. The process of claim 1, wherein the media streaming connection comprises a single connection, the single connection comprising one of an http connection or a tcp/ip connection, the single connection including media data and control data.

8. A system for rapidly determining a media streaming frame rate, the system comprising:
a media streaming device comprising a processor, the media streaming device configured to:
receive, from a media client, a request that the media streaming device stream media to the media client;
exchange, by way of the network, at least one data packet with the media client to initialize a media streaming connection with the media client,
determine, prior to transmission of a first media frame to the media client and based upon the data packet exchange, a frame rate at which to stream the media to the media client, and
stream media to the media client at the determined frame rate.

9. The system of claim 8, the media streaming device further configured to determine a network latency based upon the data packet exchange.

10. The system of claim 8, the media streaming device further configured to determine a number of network hops associated with the data packet exchange.

11. The system of claim 8, the media streaming device further configured to determine a frame rate at which to stream the media to the media client based upon a number of network hops associated with the data packet exchange.

12. The system of claim 8, the media streaming device further configured to determine a resolution at which to stream the media to the media client based upon a number of network hops associated with the data packet exchange.

13. The system of claim 8, the media streaming device further configured to determine an estimated bandwidth of the media streaming connection based upon the data packet exchange.

14. The system of claim 8, wherein the media streaming connection comprises a single connection, the single connection comprising one of an http connection or a tcp/ip connection, the single connection including media data and control data.

15. A method for streaming media to guide a disabled individual, the system comprising:
receiving, by a wearable media streaming device and from a wearable media capture device, an image captured by the wearable media capture device;
encoding, by the wearable media streaming device, the image in real time; and
streaming, by the wearable media streaming device, the encoded image to a media client, the media client associated with an operator designated to assist the disabled individual in real time.

16. The method of claim 15, further comprising receiving, by the media streaming device, and in response to the streaming in real time, data that guides the disabled individual.

17. The method of claim 15, further comprising streaming, by the wearable media streaming device and to the media client, voice data received from the disabled individual.

18. The method of claim 15, further comprising exchanging, by the wearable media streaming device, at least one data packet with the media client to initialize a media streaming connection with the media client.

19. The method of claim 18, further comprising determining, prior to transmission of a first media frame, by the wearable media streaming device to the media client, and based upon the data packet exchange, a frame rate at which to stream the encoded image to the media client.

20. The method of claim 18, further comprising determining, prior to transmission of a first media frame, by the wearable media streaming device to the media client, and based upon the data packet exchange, a resolution at which to stream the encoded image to the media client.
